(19) United States
(12) Patent Application Publication
(10) Pub. No.: US 2026/0324647 A1
(43) Pub. Date: Oct. 22, 2026

(54) METHOD FOR PREVENTION AND CONTROL OF APHIDS ON PLANTS

(71) Applicant: Foshan University, Foshan (CN)

(72) Inventors: Min Yu, Foshan (CN); Luping Gu, Foshan (CN); Wenjie Chen, Foshan (CN); Guiyu Zhou, Foshan (CN); Huiyu Zhang, Foshan (CN); Yalin Li, Foshan (CN); Xuewen Li, Foshan (CN); Jingwen Mai, Foshan (CN); Qiuyu Huang, Foshan (CN); Yunhan Chen, Foshan (CN); Wanyu Tian, Foshan (CN)

(21) Appl. No.: 19/653,025

(22) Filed: Apr. 20, 2026

(30) Foreign Application Priority Data
Apr. 21, 2025 (CN) 202510502696.6

(51) Int. Cl. A01N 59/14; A01P 7/04; A01P 21/00; C05B 7/00; C05C 3/00; C05C 5/04; C05D 1/02; C05D 5/00; C05D 9/02; C05F 11/00; C05G 3/60; C05G 5/23

(52) U.S. Cl. CPC A01N 59/14; A01P 7/04; A01P 21/00; C05B 7/00; C05C 3/00; C05C 5/04; C05D 1/02; C05D 5/00; C05D 9/02; C05F 11/00; C05G 3/60; C05G 5/23

(57) ABSTRACT

The present disclosure provides a method for prevention and control of aphids on plants, and the specific steps are: selecting plant germinated seeds that have grown roots and with root length being 2 to 6 cm, applying a photoperiod treatment of 8 h of illumination and 16 h of darkness per cycle in response to growth of the plant germinated seeds; in the plant germinated seeds, seed sources including legumes, cruciferous vegetables; simultaneously, in response to growth of the plant germinated seeds, applying a boron-containing nutrient solution including the following composition: Ca(NO₃)₂·4H₂O 4 mM, KH₂PO₄ 1 mM, KCl 1 mM, MgSO₄·7H₂O 2 mM, K₂SO₄ 0.5 mM, FeSO₄·7H₂O 50 μM, EDTA·Na₂ 50 μM, MnCl₂ 10 μM, ZnSO₄·7H₂O 5 μM, CuSO₄·5H₂O 0.5 μM, (NH₄)₆Mo₇O₂₄·4H₂O 1 μM, H₃BO₃ 35 to 70 μM, CoCl₂ 0.5 μM.

### CROSS REFERENCE TO RELATED APPLICATIONS

The present disclosure claims the priority of Chinese Patent Application No. 202510502696.6 filed on Apr. 21, 2025 before CNIPA. All the above are hereby incorporated by reference in their entirety.

### TECHNICAL FIELD

The present disclosure relates to the technical field of agricultural pest green prevention and control, and specifically relates to a method for prevention and control of aphids on plants.

### BACKGROUND

Aphids are a common pest causing numerous harms to plants, agricultural production, and ecosystems, with specific aspects as follows: (1) puncturing and sucking plant leaves and fruits, causing nutrient deficiency in plants, stalling or delaying tissue growth, leading to premature aging, and affecting flowering, fruit quality, and yield; secreting honeydew, which contaminates leaves and fruits, inducing sooty mold disease and further impairing plant photosynthesis; (2) being a major vector of plant viral diseases; transmitting viruses to healthy plants during feeding on sap, resulting in widespread viral disease outbreaks that severely impact crop yield and quality; (3) secreting honeydew that attracts ants and other saprophytic fungi; these fungi forming sooty mold on leaves, covering the leaf surface, obstructing photosynthesis, and causing hindered plant growth; (4) impeding the approach and predation of pollinating insects and natural enemies of aphids, further exacerbating their negative impact on the ecosystem.

In some implementations, aphids prefer feeding on plant tissues with high sugar content, and the accumulation of soluble sugars within plants significantly increases the feeding rate and reproduction rate of aphids.

Currently, methods for aphid prevention and control mainly include the following: (1) Chemical control: using pesticides such as imidacloprid, thiamethoxam (neonicotinoids), sulfoxaflor, and pyrethroids; but possibly causing excessive pesticide residues in agricultural products, threatening consumer health, and even violating food safety standards; long-term residues potentially contaminating soil and water sources and affecting the ecological environment; frequently using a single pesticide accelerating the development of aphid resistance, leading to reduced efficacy, requiring increased doses or alternative agents, and forming a vicious cycle; broad-spectrum insecticides potentially mistakenly killing beneficial insects like bees and ladybugs, disrupting ecological balance, and affecting pollination and the control role of natural enemies. (2) Biological control: introducing predatory or parasitic natural enemies such as ladybugs, lacewings, and aphid parasitoid wasps, or using microbial agents like fungi (e.g., Beauveria bassiana, Metarhizium anisopliae) or botanical pesticides (e.g., matrine); but the pest control effectiveness of natural enemies being greatly influenced by environmental factors (temperature, humidity) and field management, possibly failing under harsh weather or insufficient natural enemy numbers; and introducing foreign natural enemies posing risks of competition or invasion to local species (e.g., improperly introduced parasitic wasps potentially attacking non-target insects); microbial agents (e.g., fungi) being easily inactivated under strong ultraviolet light or dry conditions. (3) Agricultural control: practicing crop rotation and planting non-host crops to reduce aphid host plants; or clearing field weeds and diseased residues to destroy aphid habitats; or planting aphid-resistant or virus-resistant crop varieties; but crop rotation requiring long-term planning, potentially difficult to implement due to limited land or economic benefit issues; breeding cycles for pest-resistant varieties being long, and potentially gradually losing effectiveness due to adaptive evolution of aphids. (4) Physical control: using aphids' phototaxis to sticky-trap adults with yellow traps; or blocking aphid migration into fields with nets; but such methods having obvious limitations or high costs, such as yellow traps being effective only against adults, unable to control nymphs and eggs, requiring combination with other methods, and insect-proof nets having high costs, potentially affecting ventilation and illumination, and leading to restricted crop growth.

In view of this, providing a novel method for reducing plant aphid infestation is of significant importance for improving agricultural output value and promoting the healthy development of agriculture.

### SUMMARY

To solve the problems and deficiencies in the prior art, the present disclosure provides a method for prevention and control of aphids on plants, the method is a green prevention and control method, by adding a specific concentration of boron to the nutrient solution, may effectively regulate sugar metabolism during plant growth, and may further combine with a specific illumination and darkness cycle, inhibit sugar accumulation, thereby may significantly reduce the feeding rate and reproduction rate of aphids, playing a good role in prevention and control of aphids, which is green and efficient, applicable to sustainable pest management of multiple plants, such as legumes, cruciferous vegetables, and other crops.

The present disclosure provides a method for prevention and control of aphids on plants, specific steps including: selecting a plant germinated seed that has grown a root with a root length of 2 to 6 cm, in a plant germinated seed growth process, applying an illumination of 8 h and a darkness of 16 h in a cycle mode for photoperiod treatment; in the plant germinated seeds, seed sources including legumes, cruciferous vegetables; simultaneously in the plant germinated seed growth process, using a boron-containing nutrient solution including following compositions: Ca(NO₃)₂·4H₂O 4 mM, KH₂PO₄ 1 mM, KCl 1 mM, MgSO₄·7H₂O 2 mM, K₂SO₄ 0.5 mM, FeSO₄·7H₂O 50 μM, EDTA·Na₂ 50 μM, MnCl₂ 10 μM, ZnSO₄·7H₂O 5 μM, CuSO₄·5H2O 0.5 μM, (NH₄)₆Mo₇O₂₄·4H2O 1 μM, H₃BO₃ 35 to 70 μM, CoCl₂ 0.5 μM; and applying nutrient elements according to the following steps: 1 applying the first boron-containing nutrient solution for 1 to 5 d, a concentration of all compositions in the first boron-containing nutrient solution being 20% to 30% of the boron-containing nutrient solution; 6 applying the second boron-containing nutrient solution for 6 to 15 d, a concentration of all compositions in the second boron-containing nutrient solution being 40% to 60% of the boron-containing nutrient solution.

Aphids are worldwide pests, their distribution range is wide and may cause huge losses to agricultural production. As mentioned in the foregoing background art, currently, regarding prevention and control of aphids, it is not environmentally friendly enough, or not conducive to actual operation, or the cost is high. Therefore, using a green and environmentally friendly method to control the harm of pests is the key to sustainable agricultural development.

Thus, the present disclosure provides an environmentally friendly, efficient, easy to operate, and low-cost plant aphid prevention and control method, by applying a boron-containing nutrient solution to plant seedlings, may effectively regulate sugar metabolism of plant seedlings, thereby reducing the soluble sugar content in plant seedlings, because aphids prefer to feed on plant tissues with high sugar content, accumulation of soluble sugar in plants significantly increases the feeding rate and reproduction rate of aphids. Thus, the present disclosure, by applying the boron-containing nutrient solution to plant seedlings to reduce the soluble sugar content, may effectively reduce the feeding rate and reproduction rate of aphids, thereby playing an effective role in prevention and control of aphids.

Specifically, first, in the boron-containing nutrient solution provided by the present disclosure, the boron element may, by regulating the activity of key enzymes in plant sugar metabolism (such as inhibiting sucrose synthase), reduce the soluble sugar content, thereby reducing the feeding rate and reproduction rate of aphids, playing an effective role in prevention and control of aphids. In addition, the boron-containing nutrient solution further includes other specific macronutrients, iron salts, trace elements, etc., these components are added in specific salts and boric acid, may further promote the boron element to reduce the soluble sugar content in plants, and may simultaneously promote healthy growth of plants, avoiding malnutrition or other diseases in plants, beneficial to improving the quality of harvested peas. For example, the soluble sugar content in plants is affected by elements such as nitrogen, phosphorus, potassium, magnesium, etc., and different elements have different interactions, they may collectively influence the level of soluble sugar content in plants, Therefore, under the boron-containing nutrient solution provided by the present disclosure, the combination of specific components at specific concentrations exerts a further role in reducing the soluble sugar content in plants, effectively improving the effect of plants in prevention and control of aphids. Moreover, boric acid and other nutrient solution components may have a certain influence on the reproductive system of aphids, interfering with their reproduction process, thereby further reducing the reproduction rate of aphids. In some implementations, boric acid and other nutrient solution components may also enhance the plant cell wall structure, hindering the piercing of aphid mouthparts, reducing the feeding efficiency. At the same time, boric acid and other nutrient solution components may also cause plants to produce some secondary metabolites toxic to aphids, or change the physical properties of the plant surface, such as thickening of the wax layer on the leaf surface, etc., unfavorable for attachment and survival of aphids.

Second, applying the boron-containing nutrient solution provided by the present disclosure while applying a specific photoperiod, compared with the usual 12 h illumination/12 h darkness illumination cycle, the above-mentioned photoperiod with shorter illumination time is more conducive to exerting the effect with the boron-containing nutrient solution to a greater extent, especially, the synergistic effect with boron may further regulate sugar metabolism of plants, thereby further reducing the soluble sugar content in plants, further improving the effect of prevention and control of aphids, and may simultaneously promote the balance of various physiological processes in plants, beneficial to the process of plant growth, or plants with better quality.

Third, the present disclosure, by applying boron-containing nutrient solutions of different concentrations at different growth stages, is more conducive to growth and development of plants, taking into account various physiological performances of plant growth, and if plant growth and development are good, it is more conducive to regulating or influencing the sugar metabolism situation in plants, especially during long-term experiments, the applicant found, applying boron-containing nutrient solutions of specific concentrations at the above different periods, with the growth of plants, may be more conducive to further reducing the soluble sugar content in plants, therefore may effectively reduce the feeding rate and reproduction rate of aphids. Because applying nutrient solutions of specific concentrations at the above different periods is more conducive to promoting plant root system development, branch and leaf growth, etc., helping plants grow robustly. Plants growing well may better resist aphid infestation, because robust plants usually produce more defense substances, and have stronger compensation and repair capabilities, thereby reducing the losses caused by aphid damage. Peas are in the seedling stage from 1 to 5 d, the root system is not fully developed, the nutrition demand is low. Using 20 to 30% boron-containing nutrient solution may avoid nutrition excess, while providing sufficient nutrition to support seedling growth. Peas enter the rapid growth stage from 6 to 15 d, the root system gradually becomes developed, the nutrition demand increases. Using 40 to 60% boron-containing nutrient solution may satisfy the higher nutrition demand of plants, promoting rapid growth of stems, leaves, and root systems. Moreover, the boron-containing nutrient solution provided by the present disclosure contains many specific nutrition components, also plays a very key role in promoting healthy growth and development of plants, the nutrient solution obtained by mixing the above specific components in specific proportions is more conducive to plant growth, thereby more conducive to prevention and control of aphids.

Moreover, the present disclosure, only by applying the boron-containing nutrient solution to plants, achieves effective prevention and control of aphids, compared with methods in the prior art such as using pesticides or introducing natural enemies, is greener and more environmentally friendly, beneficial to sustainable development of agriculture.

In summary, the combination of specific photoperiod and specific boron-containing nutrient solution treatment both avoids the negative impact of single light regulation on plant growth, and reduces sugar content through dual pathways, while significantly improving the effect of aphid prevention and control, is more conducive to the balance of various physiological processes in plants, promoting plant growth.

In some implementations, legumes include at least one of soybean, green bean, black bean, red bean, mung bean, kidney bean, pea, broad bean, chickpea, lentil.

In some implementations, the cruciferous vegetable includes at least one selected from Chinese cabbage, bok choy, rapeseed, radish, kale, cauliflower, cabbage, broccoli, potherb mustard, shepherd's purse, mustard, purple stem pakchoi, red stem pakchoi, watercress, Orychophragmus violaceus, watercress, horseradish, and pickled mustard tuber.

In some implementations, the plant germination seedling includes a pea germination seed, and the root length of the pea germination seed is 3 cm to 4 cm.

The present disclosure indicates through related experiments that applying a boron-containing nutrient solution to peas may effectively regulate sugar metabolism in the peas, reducing the soluble sugar content within the peas; therefore, it may effectively reduce the feeding rate and reproduction rate of aphids on the peas, thereby reducing the aphid population; it may effectively prevent and control pea aphids, providing a favorable external environment for the healthy growth of peas; it may provide a cultivation direction for mass cultivation of high-quality peas, benefiting healthy and ecological agricultural development.

In some implementations, in the plant germinated seed growth process, and applying nutrient elements according to the following steps: 1 applying the first boron-containing nutrient solution for 1 to 5 d, a concentration of all compositions in the first boron-containing nutrient solution being 25% of the boron-containing nutrient solution; 6 applying the second boron-containing nutrient solution for 6 to 15 d, a concentration of all compositions in the second boron-containing nutrient solution being 50% of the boron-containing nutrient solution.

In some implementations, in the plant germinated seed growth process, and applying nutrient elements according to the following steps: 1 applying the first boron-containing nutrient solution for 1 to 5 d, a concentration of all compositions in the first boron-containing nutrient solution being 20% to 30% of the boron-containing nutrient solution; 6 applying the second boron-containing nutrient solution for 6 to 15 d, a concentration of all compositions in the second boron-containing nutrient solution being 40% to 60% of the boron-containing nutrient solution; 16 applying the third boron-containing nutrient solution for 16 to 25 d, a concentration of all compositions in the third boron-containing nutrient solution being 90% to 100% of the boron-containing nutrient solution.

In some implementations, in the plant germinated seed growth process, and applying nutrient elements according to the following steps: 1 applying the first boron-containing nutrient solution for 1 to 5 d, a concentration of all compositions in the first boron-containing nutrient solution being 25% of the boron-containing nutrient solution; 6 applying the second boron-containing nutrient solution for 6 to 15 d, a concentration of all compositions in the second boron-containing nutrient solution being 50% of the boron-containing nutrient solution; 16 applying the third boron-containing nutrient solution for 16 to 25 d, a concentration of all compositions in the third boron-containing nutrient solution being consistent with the boron-containing nutrient solution.

In some implementations, in the boron-containing nutrient solution, the concentration of boron is 70 μM. Controlling the concentration of boron to be 70 μM is more conducive to regulating sugar metabolism in the plant, reducing the soluble sugar content within the plant, is more conducive to preventing and controlling aphids, and promoting the good growth of the plant.

In some implementations, the boron-containing nutrient solution is replaced or re-applied every 3 to 7 days. The boron-containing nutrient solution includes a first boron-containing nutrient solution or a second boron-containing nutrient solution or a third boron-containing nutrient solution.

In some implementations, the boron-containing nutrient solution is replaced or re-applied every 3 to 7 days for 2 to 5 consecutive treatments.

In some implementations, the boron-containing nutrient solution is replaced or re-applied every 5 days for 3 consecutive treatments.

In some implementations, the pH of the boron-containing culture solution is 5 to 6.5.

In some implementations, during the illumination treatment, the light source includes at least one selected from natural light and white light, and the intensity of the light source is 1000 to 3000 Lux.

In some implementations, the light source includes LED white light.

In some implementations, during the growth process of the plant germination seed, the temperature is controlled to be 20 °C to 27 °C, and the humidity is controlled to be 60% to 70%.

In some implementations, during the growth process of the plant germination seed, the culture method includes at least one selected from aeroponics, hydroponics, and soil culture.

In some implementations, during the growth process of the plant germination seed, the method of applying the boron-containing nutrient solution includes at least one selected from soil irrigation, foliar spray, and root soaking. In some implementations, during the growth process of the plant germination seed, soil culture is adopted, and the method of applying the boron-containing nutrient solution includes at least one selected from soil irrigation and foliar spray. In some implementations, during the growth process of the plant germination seed, hydroponics or aeroponics is adopted, and the method of applying the boron-containing nutrient solution includes at least one selected from foliar spray and root soaking.

In some implementations, the culture method for obtaining the plant germination seed includes at least one selected from aeroponics, hydroponics, and soil culture.

In some implementations, a plant seedling is obtained by using the plant germination seed via a hydroponic or soil culture method.

In summary, the method for preventing and controlling plant aphids provided by the present disclosure has the following beneficial effects:

Targeted prevention and control: directly reducing aphid feeding motivation by lowering plant soluble sugar content, reducing reliance on chemical pesticides. Eco-friendly: photoperiod regulation and the boron element are physical or normal nutrient element application means, with no residual pollution. Synergistic enhancement: the boron element may regulate plant sugar metabolism, reducing plant soluble sugar content, and further combined with a specific photoperiod, may synergistically enhance the regulatory effect of boron on sugar metabolism, optimizing the effect of preventing and controlling plant aphids. (4) Universality: the method provided by the present disclosure may be applied to many aphid-susceptible crops, such as legumes and cruciferous vegetables.

### BRIEF DESCRIPTION OF THE DRAWINGS

FIGS. 1 and 2 show quantitative and qualitative results of soluble sugar content in pea leaves in response to treatment with two boron levels of 35 μM H₃BO₃ (low boron) and 70 μM H₃BO₃ (high boron) and treatment with two photoperiods (8 h illumination/16 h darkness cycles and 12 h illumination/12 h darkness cycles) after the peas were cultured for 15 days. In FIG. 2, the coloration map of the soluble sugar content indicates changes in the content, where a darker color indicates a higher sugar content, and conversely, a lighter color indicates a lower sugar content; the coloration of the low boron soluble sugar content is significantly more pronounced, so the soluble sugar content of the plant is high.

FIG. 3 shows quantitative results of aphid on pea leaf statistics in response to treatment with two boron levels of 35 μM H₃BO₃ (low boron) and 70 μM H₃BO₃ (high boron) and treatment with two photoperiods (8 h illumination/16 h darkness cycles and 12 h illumination/12 h darkness cycles) after the peas were cultured for 25 days. FIG. 4 shows photographic results of aphid on pea leaf statistics in response to treatment with two boron levels of 35 μM H₃BO₃ (low boron) and 70 μM H₃BO₃ (high boron) and treatment with two photoperiods (8 h illumination/16 h darkness cycles and 12 h illumination/12 h darkness photoperiods) after the peas were cultured for 25 days.

### DETAILED DESCRIPTION

In order to better enable those skilled in the art to understand the solution of the present disclosure, the technical solutions in the examples of the present disclosure will be clearly and completely described below; obviously, the described examples are only a part of the examples of the present disclosure, and not all examples.

### Example 1

In the present example, germinated pea seeds with a root length of 3 to 4 cm are selected, and the culture method is hydroponics, specifically including the following steps:

selecting germinated pea seeds with a root length of 3 to 4 cm, placing them in a nutrient solution (pH 5.5) for culture, and culturing at 24 °C, 65% relative humidity, and a light intensity of 3000 Lux (LED white light) for 25 d;

during the growth process of the germinated pea seeds, the boron-containing nutrient solution includes the following compositions: Ca(NO₃)₂·4H₂O 4 mM, KH₂PO₄ 1 mM, KCl 1 mM, MgSO₄·7H₂O 2 mM, K₂SO₄ 0.5 mM, FeSO₄·7H₂O 50 μM, EDTA·Na₂ 50 μM, MnCl₂ 10 μM, ZnSO₄·7H₂O 5 μM, CuSO₄·5H2O 0.5 μM, (NH₄)₆Mo₇O₂₄·4H2O 1 μM, H₃BO₃ 35 to 70 μM, CoCl₂ 0.5 μM; and applying nutrient elements according to the following steps:

(1) using a first boron-containing nutrient solution from days 1 to 5, where the concentration of all components in the first boron-containing nutrient solution is 25% of that in the boron-containing nutrient solution; (2) using a second boron-containing nutrient solution from days 6 to 15, where the concentration of all components in the second boron-containing nutrient solution is 50% of that in the boron-containing nutrient solution; (3) using a third boron-containing nutrient solution from days 16 to 25, where the concentration of all components in the third boron-containing nutrient solution is consistent with that in the boron-containing nutrient solution; where, the concentration of boric acid varies according to different treatment groups set below.

In the present example, setting two boron levels 35 μM H₃BO₃ (low boron), 70 μM H₃BO₃ (high boron) treatments and two photoperiod (8 h illumination/16 h darkness cycle, 12 h illumination/12 h darkness cycle) treatments. The boron source is boric acid (HBO), a white crystalline powder, weakly acidic. Boron is added by adding it to the aforementioned nutrient solution, and the pH of the culture solution is 5.5.

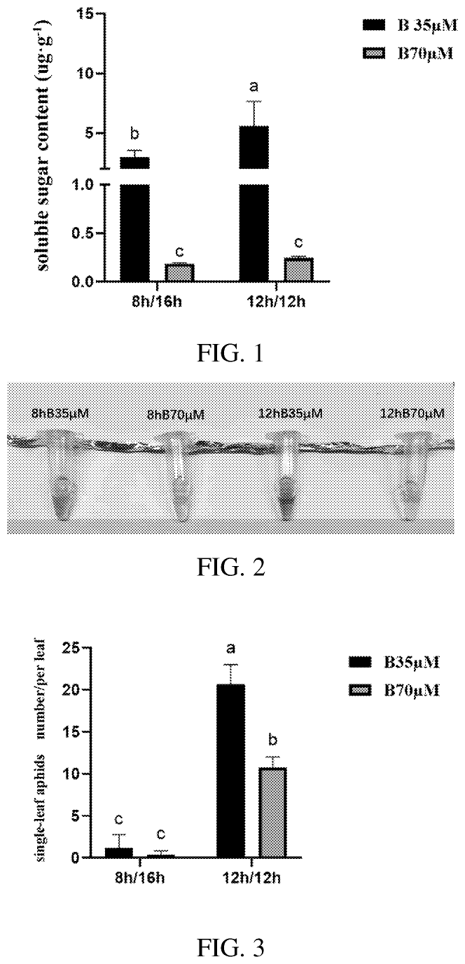

Aphids are found after culturing peas for 15 d, taking leaves for measuring soluble sugar content, and the results are shown in FIGS. 1 and 2. The specific steps for taking leaves to measure soluble sugar content are as follows:
sample collection: collecting leaves of peas (Zhongwan No. 6) after culturing peas in nutrient solutions containing 35 μM and 70 μM H₃BO₃ for 15 d;
sample extraction: weighing about 0.1 to 0.2 g of fresh sample, adding 1 ml of distilled water, grinding into a homogenate at room temperature and transferring to a 2 ml centrifuge tube; placing it in a boiling water bath for 10 min and then cooling; centrifuging at 25 °C and 8000 g for 10 min, taking the supernatant into a 10 ml test tube, using distilled water to adjust the volume to 10 mL, shaking well for measurement;
sample detection: using the anthrone colorimetric method to determine the soluble sugar content in the sample; taking 40 μl of the aforementioned solution to be measured, sequentially adding 40 μl of distilled water, 20 μl of anthrone reagent, 200 μl of concentrated sulfuric acid, mixing thoroughly and placing in a 95 °C water bath for 10 min, cooling to room temperature, pipetting 200 μl into a 96-well enzyme-linked immunosorbent assay plate, using a microplate reader (EnSight full-wavelength microplate reader, PerkinElmer, China) to measure its absorbance (OD value) at a wavelength of 620 nm; calculating the plant soluble sugar concentration in the sample according to a standard curve.

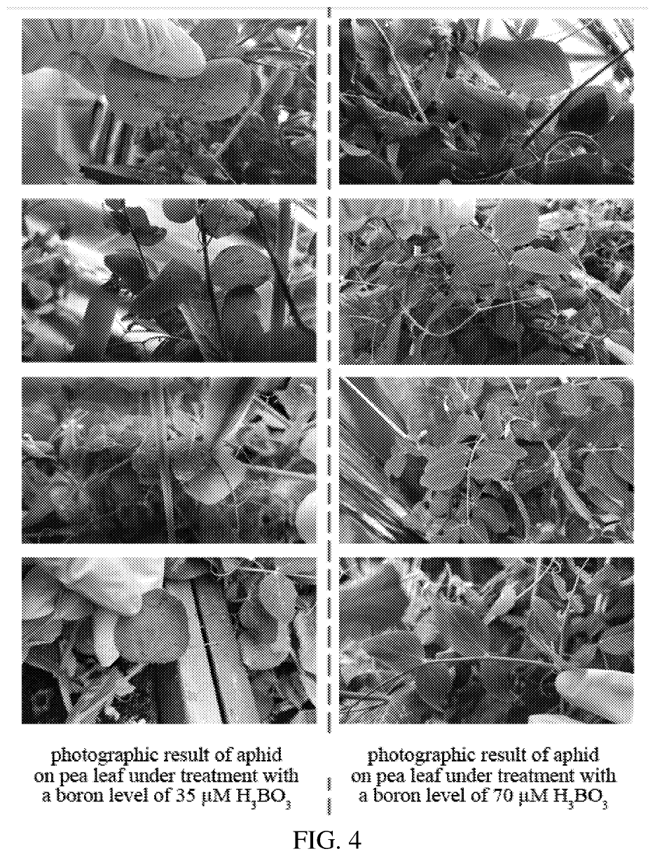

Photographing and performing pest condition statistics after culturing for 25 d, and the results are shown in FIGS. 3 and 4.

As may be seen from FIGS. 1 and 2, after culturing peas for 15 d, under both photoperiod conditions, the soluble sugar content of pea seedlings treated with 35 μM boron (B 35 μM) is significantly higher than that treated with 70 μM boron (B 70 μM). Under the B 35 μM condition, the soluble sugar content of pea seedlings cultured under the 12 h illumination/12 h darkness photoperiod is significantly higher than that under the 8 h illumination/16 h darkness photoperiod; there is no significant difference in sugar content between the two photoperiods for pea seedlings under the B 70 μM condition. The results indicate that higher concentration boron treatment significantly reduces the soluble sugar content of pea seedlings, especially under the 12 h illumination/12 h darkness photoperiod condition, where the soluble sugar content decreases by 23 times.

As may be seen from FIGS. 3 and 4, after culturing for 25 d, statistics on aphids on pea leaves reveal that the number of aphids on pea seedlings under the 8 h illumination/16 h darkness photoperiod is very low, the number of aphids on pea seedlings cultured under the 12 h illumination/12 h darkness photoperiod is significantly higher than that on pea seedlings cultured under the 8 h illumination/16 h darkness photoperiod, and the B 35 μM treatment is significantly higher than the B 70 μM treatment. This indicates that pea seedlings cultured under the 12 h illumination/12 h darkness photoperiod are prone to aphid infestation, and high boron may reduce aphid infestation.

### Example 2

The present example differs from Example 1 in that, in the photoperiod, the light source intensity is 800 Lux, and the B 70 μM treatment is applied; the rest is consistent with Example 1.

Similarly, after culturing peas for 15 d, taking leaves to measure soluble sugar content (the specific steps for taking leaves to measure soluble sugar content are consistent with Example 1), it is found that too low light source intensity leads to a significant decrease in soluble sugar content in pea leaves, primarily because low light reduces photosynthetic efficiency, decreases sugar synthesis, and simultaneously, plants prioritize transporting limited sugar to key parts such as roots, leading to reduced sugar accumulation in leaves. Prolonged low light may also cause leaf yellowing, further reducing sugar content. This phenomenon reflects the important influence of light intensity on plant carbon metabolism and growth development. In experiments or production, suitable illumination conditions need to be ensured to maintain normal plant growth and metabolism.

Photography and insect situation statistics were performed after 25 days of culture, and it was found that compared with Example 1, an excessively low light source intensity leads to a significant increase in aphid numbers on pea plants, the main reasons being that weak light reduces the synthesis of plant anti-insect substances while promoting protein breakdown to increase amino acids favored by aphids; leaves become thinner and softer, making them easier to pierce and suck; more odors attracting aphids are released, and a humid and cool suitable environment is formed; these changes collectively lead to aphids surviving and reproducing more easily.

### Example 3

In the present example, the difference from Example 1 is that, in the photoperiod, the light source intensity is 4000 Lux, and the boron treatment is 70 μM; the rest is consistent with Example 1.

Similarly, after 15 days of pea culture, leaves were taken to determine soluble sugar content (the specific steps for taking leaves to determine soluble sugar content are consistent with Example 1), and it was found that an excessively high light source intensity may lead to an increase in soluble sugar content in pea leaves, mainly due to enhanced photosynthesis promoting sugar synthesis, while the sugar transport rate temporarily may not keep up with the synthesis speed; in some implementations, plants accumulate more soluble sugar in response to high light stress.

Photography and insect situation statistics were performed after 25 days of culture, and it was found that compared with Example 1, an excessively high light source intensity leads to a significant reduction in aphid numbers on pea plants, the main reasons being that under high light conditions, an increase in plant defense-related metabolites, changes in volatile composition, and alterations in physical structure reduce the plant's attractiveness to aphids. However, if the light intensity is excessively high, it may suppress aphids by inducing defense mechanisms in the short term, but long-term stress leads to photosynthetic system damage, metabolic imbalance, structural weakening, and degradation of ecosystem functions, weakening plant chemical defense capabilities and altering their volatile signals, which is detrimental to the growth and development of pea plants.

### Comparative Example 1

In the present comparative example, the difference from Example 1 is that boron is not applied in the nutrient solution, and the photoperiod adopts an 8 h illumination/16 h darkness cycle; the rest is consistent with Example 1.

Similarly, after 15 days of pea culture, leaves were taken to determine soluble sugar content (the specific steps for taking leaves to determine soluble sugar content are consistent with Example 1), and it was found that under conditions of boron deficiency and a photoperiod of 8 hours illumination/16 hours darkness cycle, the soluble sugar content in pea leaves is significantly reduced, mainly because boron deficiency obstructs photosynthetic product transport and causes metabolic disorders, while short illumination limits photosynthesis efficiency.

Photography and insect situation statistics were performed after 25 days of culture, and it was found that under conditions of boron deficiency and a photoperiod of 8 hours illumination/16 hours darkness cycle, aphid numbers on pea plants are significantly increased, the main reasons being that boron deficiency also reduces the synthesis of plant anti-insect substances while promoting protein breakdown to increase amino acids favored by aphids; leaves become thinner and softer, making them easier to pierce and suck; more odors attracting aphids are released, and a humid and cool suitable environment is formed; these changes collectively lead to aphids surviving and reproducing more easily.

### Comparative Example 2

In the present comparative example, the difference from Example 1 is that, in the photoperiod, a 24 h complete darkness cycle is set, with high boron treatment (B 70 μM); the rest is consistent with Example 1.

Similarly, after 15 days of pea culture, leaves were taken to determine soluble sugar content (the specific steps for taking leaves to determine soluble sugar content are consistent with Example 1), and it was found that under complete darkness, the soluble sugar content in pea leaves is significantly reduced, mainly because photosynthesis completely stops, plants may not synthesize new carbohydrates, and they rely on seed storage materials to maintain life activities.

Photography and insect situation statistics were performed after 25 days of culture, and it was found that under complete darkness, aphid numbers on pea plants may be significantly reduced or even disappear, the main reasons being that plant soluble sugar and amino acid contents are extremely low, while plant growth stagnation and changes in volatile composition cause the plant to lose attractiveness to aphids. Simultaneously, the growth stagnation of pea plants causes them to become thin and weak, with leaves turning yellow and thinning, unable to grow normally, and therefore further consumption and utilization is not possible.

### Comparative Example 3

In the present comparative example, the difference from Example 1 is that the photoperiod adopts an 8 h illumination/16 h darkness cycle, and the boron concentration in the nutrient solution is higher, at 80 μM; the rest is consistent with Example 1.

Similarly, after 15 days of pea culture, leaves were taken to determine soluble sugar content (the specific steps for taking leaves to determine soluble sugar content are consistent with Example 1), and it was found that when the boron concentration is excessively high, especially under the photoperiod condition of 8 hours illumination/16 hours darkness, the test results of soluble sugar in leaves taken after 15 days of pea culture show a decrease in soluble sugar content. This is because, as boron excess inhibits sugar metabolism enzyme activity, interferes with carbon allocation balance, and triggers cell membrane damage, leading to reduced sugar synthesis and increased leakage.

Photography and insect situation statistics were performed after 25 days of culture, and it was found that under the condition of 8 hours illumination/16 hours darkness, the effects of two different concentrations of B treatment (35 μM and 70 μM) on the number of single-leaf aphids are not significant, with aphid numbers being relatively low in both cases. This is because short-day illumination itself strongly activates plant anti-insect defense systems (such as inducing defense substance synthesis and altering volatile substances), leaving limited room for enhancement by boron treatment; simultaneously, under short-day conditions, a 35 μM boron concentration already meets basic anti-insect needs, and the marginal benefit of a higher concentration (70 μM) is not obvious. In some implementations, short-day illumination also directly suppresses aphid activity, collectively causing aphid numbers under both boron treatments to remain at low levels.

### Comparative Example 4

In the present comparative example, the difference from Example 1 is that boron is not applied during days 1 to 5 of pea seedling growth, and boron (B 70 μM) is applied subsequently from days 6 to 15; the rest is consistent with Example 1.

Similarly, after 15 days of pea culture, leaves were taken to determine soluble sugar content (the specific steps for taking leaves to determine soluble sugar content are consistent with Example 1), and it was found that a later time of boron application may miss the critical period of plant growth, thereby affecting soluble sugar accumulation and overall plant growth, therefore causing the increase in soluble sugar content in the present comparative example. Because boron deficiency inhibits the activity of key enzymes for sugar transport, while obstructing the growth of new tissues, causing photosynthetic products to accumulate in leaves and not be effectively transported and utilized.

Photographs were taken and insect infestation statistics were conducted after culturing for 25 d, discovering that applying boron at a later time misses the critical period for aphid prevention and control, leading to poor aphid prevention and control effects and a higher number of aphids appearing on the plants. This is because missing the key prevention window at the seedling stage prevents boron from participating in cell wall reinforcement and defense substance synthesis; applying boron later may not timely activate the jasmonic acid defense pathway, leading to insufficient accumulation of insect-resistant substances (phenolic compounds, lignin); early settled aphids have already established a population advantage, with the key point being that the defensive effect of boron is time-sensitive, and delayed application significantly reduces prevention and control efficiency.

### Comparative Example 5

The present comparative example differs from Example 1 in that, during the growth of the pea seedlings, the added nutrient solution does not contain cobalt chloride (CoCl₂); the rest is consistent with Example 1.

Similarly, after culturing peas for 15 d, leaves were taken to determine the soluble sugar content (the specific steps for taking leaves to determine soluble sugar content are consistent with Example 1), and it was found that not adding CoCl₂ leads to an increase in the soluble sugar content within the plant body. This is mainly because cobalt deficiency hinders sugar metabolism and transport while reducing sugar consumption by new tissues, causing sugar to accumulate in leaves. However, long-term cobalt deficiency will lower sugar content due to decreased photosynthetic capacity.

Photographs were taken and insect infestation statistics were conducted after culturing for 25 d, discovering that the prevention and control effect on aphids is adversely affected if CoCl₂ is not added to the nutrient solution, and a higher number of aphids appears on the plants. This is because cobalt deficiency weakens the synthesis of plant insect-resistant metabolites, increases the content of free amino acids favored by aphids, and simultaneously weakens the cell wall structure; these three aspects collectively reduce the plant's defense capability and increase its attractiveness to aphids.

### Comparative Example 6

The present comparative example differs from Example 1 in that, during the growth of the pea seedlings, the added nutrient solution does not contain cobalt chloride (CoCl₂) and magnesium sulfate (MgSO); the rest is consistent with Example 1.

Similarly, after culturing peas for 15 d, leaves were taken to determine the soluble sugar content (the specific steps for taking leaves to determine soluble sugar content are consistent with Example 1), and it was found that not adding CoCl₂ and MgSO₄ leads to an increase in the soluble sugar content within the plant body. When CoCl₂ and MgSO₄ are not added, the soluble sugar content in pea leaves increases in the short term (15 days), mainly because Mg²⁺ deficiency hinders sugar transport and Co²⁺ deficiency affects sugar metabolism, causing photosynthetic products to accumulate in leaves; simultaneously, nutrient deficiency inhibits new tissue growth, reducing sugar consumption.

Photographs were taken and insect infestation statistics were conducted after culturing for 25 d, discovering that the prevention and control effect on aphids is adversely affected if CoCl₂ and MgSO₄ are not added to the nutrient solution, and a higher number of aphids appears on the plants, with the number of aphids on plants in this comparative example being even higher than in Comparative Example 5. This is because magnesium deficiency weakens plant photosynthesis and the synthesis of insect-resistant secondary metabolites, while also causing free amino acid accumulation that attracts aphids; cobalt deficiency affects defense enzyme activity and lignin synthesis, with both jointly disrupting the plant's chemical defense and physical barrier functions, creating a nutritional environment more favorable for aphid feeding. This indicates that certain synergistic effects exist among multiple nutrient components, and only when they coexist may they promote pea plant growth while further improving the effect of aphid prevention and control.

In summary, the B treatment concentration has a significant effect on aphid reproduction, and this effect is regulated by illumination time. A relatively lower concentration B treatment (35 μM) under a longer illumination time (12-hour illumination/12-hour darkness) significantly promotes aphid reproduction, while a higher concentration B treatment (70 μM), although also having a certain promoting effect, is not as significant as the lower concentration. This indicates that an optimal concentration range exists for the effect of B treatment on aphid reproduction. Within the most suitable B concentration range, it may both maximize the prevention and control of aphid reproduction and synergize with other nutrient components to jointly promote plant growth and development, thereby further improving the effect of aphid prevention and control.

The above examples are only used to illustrate the technical solution of the present disclosure rather than limit the protection scope of the present disclosure; although the present disclosure has been described in detail with reference to the above examples, ordinary technicians in the field should understand that modifications or equivalent replacements may be made to the technical solution of the present disclosure, but these modifications or replacements all fall within the protection scope of the present disclosure.

What is claimed is:

1. A method for prevention and control of aphids on plants, specific steps thereof comprising:
selecting a plant germinated seed that has grown a root with a root length of 2 to 6 cm, applying, during growth of the plant germinated seed, a photoperiod treatment with a cycle of 8 h of illumination and 16 h of darkness;
wherein a seed source in the plant germinated seed comprises legume and cruciferous vegetables;
applying, during the growth of the plant germinated seed, a boron-containing nutrient solution comprising the following composition: Ca(NO₃)₂·4H₂O 4 mM, KH₂PO₄ 1 mM, KCl 1 mM, MgSO₄·7H₂O 2 mM, K₂SO₄ 0.5 mM, FeSO₄·7H₂O 50 μM, EDTA·Na₂ 50 μM, MnCl₂ 10 μM, ZnSO₄·7H₂O 5 μM, CuSO₄·5H2O 0.5 μM, (NH₄)₆Mo₇O₂₄·4H₂O 1 μM, H₃BO₃ 35 to 70 μM, CoCl₂ 0.5 μM; and applying nutrient elements according to the following steps:
(1) applying a first boron-containing nutrient solution for 1 to 5 d, wherein a concentration of all components in the first boron-containing nutrient solution is 20 to 30% of that in the boron-containing nutrient solution;
(2) applying a second boron-containing nutrient solution for 6 to 15 d, wherein the concentration of all components in the second boron-containing nutrient solution is 40 to 60% of that in the boron-containing nutrient solution.

2. The method for prevention and control of aphids on plants according to claim 1, wherein the plant germinated seed comprises a pea germinated seed, and a root length of the pea germinated seed is 3 to 4 cm.

3. The method for prevention and control of aphids on plants according to claim 1, wherein the nutrient elements, during the growth of the plant germinated seed, are applied according to the following steps:
(1) applying the first boron-containing nutrient solution for 1 to 5 d, wherein the concentration of all components in the first boron-containing nutrient solution is 25% of that in the boron-containing nutrient solution;
(2) applying the second boron-containing nutrient solution for 6 to 15 d, wherein the concentration of all components in the second boron-containing nutrient solution is 50% of that in the boron-containing nutrient solution.

4. The method for prevention and control of aphids on plants according to claim 1, wherein the nutrient elements, during the growth of the plant germinated seed, are applied according to the following steps:
(1) applying the first boron-containing nutrient solution for 1 to 5 d, wherein the concentration of all components in the first boron-containing nutrient solution is 20 to 30% of that in the boron-containing nutrient solution;
(2) applying the second boron-containing nutrient solution for 6 to 15 d, wherein the concentration of all components in the second boron-containing nutrient solution is 40 to 60% of that in the boron-containing nutrient solution;
(3) applying the third boron-containing nutrient solution for 16 to 25 d, wherein the concentration of all components in the third boron-containing nutrient solution is 90 to 100% of that in the boron-containing nutrient solution.

5. The method for prevention and control of aphids on plants according to claim 4, wherein the nutrient elements, during the growth of the plant germinated seed, are applied according to the following steps:
(1) applying a first boron-containing nutrient solution for 1 to 5 d, wherein the concentration of all components in the first boron-containing nutrient solution is 25% of that in the boron-containing nutrient solution;
(2) applying a second boron-containing nutrient solution for 6 to 15 d, wherein the concentration of all components in the second boron-containing nutrient solution is 50% of that in the boron-containing nutrient solution;
(3) applying a third boron-containing nutrient solution for 16 to 25 d, wherein the concentration of all components in the third boron-containing nutrient solution is consistent with that in the boron-containing nutrient solution.

6. The method for prevention and control of aphids on plants according to claim 1, wherein the concentration of boric acid in the boron-containing nutrient solution is 70 μM.

7. The method for prevention and control of aphids on plants according to claim 1, wherein a pH of the boron-containing culture solution is 5 to 6.5.

8. The method for prevention and control of aphids on plants according to claim 1, wherein a light source, during the illumination treatment, comprises at least one of natural light and white light, and an intensity of the light source is 1000 to 3000 Lux.

9. The method for prevention and control of aphids on plants according to claim 1, wherein a temperature, during the growth of the plant germinated seed, is controlled at 20 to 27 °C, and a humidity is controlled at 60% to 70%.

10. The method for prevention and control of aphids on plants according to claim 1, wherein a culture method, during the growth of the plant germinated seed, comprises at least one of aeroponics, hydroponics, and soil culture.
